(19) United States
(12) Patent Application Publication
(10) Pub. No.: US 2012/0296603 A1
(43) Pub. Date: Nov. 22, 2012

(54) SENSOR ORIENTATION MEASUREMENT WITH RESPECT TO PEDESTRIAN MOTION DIRECTION

(75) Inventors: Victor Kulik, San Jose, CA (US); Joseph Czompo, Santa Clara, CA (US); Christopher Brunner, San Diego, CA (US); Michael James Wengler, Carlsbad, CA (US)

(73) Assignee: QUALCOMM Incorporated, San Diego, CA (US)

(21) Appl. No.: 13/108,789

(22) Filed: May 16, 2011

(51) Int. Cl. G01C 22/00; G06F 15/00

(52) U.S. Cl. 702/160

(57) ABSTRACT

Systems and methods are described for measuring orientation of sensors associated with a mobile device with respect to pedestrian motion of a user of the mobile device. An example technique described herein includes obtaining acceleration information associated with the mobile device, partitioning the acceleration information according to respective detected pedestrian steps of the user, identifying a forward motion direction of the user of the mobile device based on the acceleration information and the detected pedestrian steps, and computing a misalignment angle between the forward motion direction of the user of the mobile device and an orientation of the mobile device.

### BACKGROUND

Wireless communication devices are incredibly widespread in today's society. For example, people use cellular phones, smart phones, personal digital assistants, laptop computers, pagers, tablet computers, etc. to send and receive data wirelessly from countless locations. Moreover, advancements in wireless communication technology have greatly increased the versatility of today's wireless communication devices, enabling users to perform a wide range of tasks from a single, portable device that conventionally required either multiple devices or larger, non-portable equipment.

Various mobile device applications, such as navigation aids, business directories, local news and weather services, or the like, leverage knowledge of the position of the device. In various cases, the position of a mobile device is identified via motion tracking with respect to the device. For example, in the case of sensor-aided pedestrian navigation applications, motion direction is determined using the orientation of the device sensors in relation to the direction of forward motion. The angle between the orientation of the mobile device and the forward motion direction is referred to as the alignment angle or misalignment angle (MA).

When calibration data (such as satellite navigation data) is available, the MA corresponding to a device can be determined using the calibration data. However, when connectivity to a satellite navigation system and/or other sources of calibration data is lost and the sensor orientation of the device changes (e.g., corresponding to movement of the device from a user's hand to the user's pocket, etc.), other techniques are required for computing or estimating the MA.

### SUMMARY

The present disclosure is directed to systems and methods for measuring sensor orientation with respect to pedestrian motion direction. An example of a mobile device according to the disclosure includes an accelerometer configured to generate acceleration information relating to motion of the device and to identify information relating to an orientation of the device, a step detector configured to identify pedestrian steps of a user of the device and corresponding pedestrian step duration information, a motion direction tracking module communicatively coupled to the accelerometer and the step detector and configured to separate a forward motion direction of the device with respect to the user of the device indicated by the acceleration information from vertical and transverse motion directions of the device based on the pedestrian steps identified by the step detector, and a misalignment angle computation module communicatively coupled to the accelerometer and the motion direction tracking module and configured to determine a misalignment angle between the forward motion direction of the device and the orientation of the device with respect to the user of the device.

Implementations of such a mobile device may include one or more of the following features. A step shifter module communicatively coupled to the motion direction tracking module and configured to shift the acceleration information in time by about one pedestrian step in accordance with the pedestrian step duration information, thereby obtaining shifted acceleration information; and a step summation module communicatively coupled to the step shifter module and the motion direction tracking module and configured to combine the acceleration information with the shifted acceleration information. The acceleration information includes horizontal acceleration information and vertical acceleration information, and the device further includes a step shifter module communicatively coupled to the motion direction tracking module and configured to shift the acceleration information forward and backward in time by about a quarter pedestrian step in accordance with the pedestrian step duration, thereby obtaining forward-shifted acceleration information and backward-shifted acceleration information, respectively; and a step correlation module communicatively coupled to the step shifter module and the motion direction tracking module and configured to compute a first correlation of vertical acceleration information with forward-shifted horizontal acceleration and to compute a second correlation of vertical acceleration information with backward-shifted horizontal acceleration information.

Implementations of such a device may additionally or alternatively include one or more of the following features. The motion direction tracking module is further configured to subtract the first correlation from the second correlation, thereby obtaining a resulting correlation. The misalignment angle computation module includes an eigen analysis module configured to determine the misalignment angle by performing eigen analysis of the resulting correlation with respect to the forward motion direction of the device. The acceleration information includes horizontal acceleration information and vertical acceleration information, and the device further includes an angle direction inference module communicatively coupled to the misalignment angle computation module and configured to resolve forward/backward ambiguity associated with the misalignment angle by analyzing horizontal acceleration information corresponding to the forward motion direction of the device in relation to the vertical acceleration information based on positivity or negativity of the resulting correlation. The step detector includes a pedometer. The step detector is communicatively coupled to the accelerometer and configured to identify the pedestrian steps of the user of the device based on the acceleration information generated by the accelerometer. The accelerometer is configured to identify a direction of gravity relative to the device and the misalignment angle computation module is further configured to determine the orientation of the device based on the direction of gravity relative to the device.

An example of a method of identifying a misalignment angle associated with motion of a mobile device according to the disclosure includes obtaining acceleration information associated with the mobile device, partitioning the acceleration information according to respective detected pedestrian steps of the user, identifying a forward motion direction of the user of the mobile device based on the acceleration information and the detected pedestrian steps, and computing a misalignment angle between the forward motion direction of the user of the mobile device and an orientation of the mobile device.

Implementations of such a method may include one or more of the following features. The obtaining includes obtaining first acceleration information corresponding to a first pedestrian step of the user and obtaining second acceleration information corresponding to a second pedestrian step of the user that follows the first pedestrian step, and the identifying includes summing the first acceleration information with the second acceleration information. The obtaining includes obtaining vertical acceleration information and horizontal acceleration information associated with the user of the mobile device and the identifying includes correlating the vertical acceleration information of a selected pedestrian step with the horizontal acceleration information of the selected pedestrian step shifted forward and backward in time by about one quarter of a pedestrian step based on a vertical/forward correlation function. The computing includes computing the misalignment angle between the forward motion direction of the mobile device and the orientation of the mobile device by performing eigen analysis of results of the vertical/forward correlation function. The computing further includes resolving forward/backward ambiguity of the misalignment angle based on positivity or negativity of the results of the vertical/forward correlation function. Identifying the respective detected steps of the user based on the acceleration information.

Another example of a mobile device according to the disclosure includes an accelerometer configured to generate acceleration information relating to motion of the device and to identify information relating to an orientation of the device; a step detector configured to identify pedestrian steps of a user of the device and corresponding pedestrian step duration information; direction means, communicatively coupled to the accelerometer and the step detector, for inferring a forward motion direction of the device from the acceleration information based on the pedestrian steps identified by the step detector; and misalignment means, communicatively coupled to the accelerometer and the direction means, for determining a misalignment angle between the forward motion direction of the user of the device and the orientation of the device with respect to the user of the device.

Implementations of such a mobile device may include one or more of the following features. Shift means, communicatively coupled to the direction means, for shifting the acceleration information in time by an interval having a length of approximately one pedestrian step in accordance with the pedestrian step duration information, and summation means, communicatively coupled to the shift means and the direction means, for combining the acceleration information with a result of the shift means. The acceleration information includes horizontal acceleration information and vertical acceleration information and the device further includes shift means, communicatively coupled to the direction means, for shifting the horizontal acceleration information forward and backward in time by an interval having a length of approximately one quarter pedestrian step in accordance with the pedestrian step duration information, first correlation means, communicatively coupled to the shift means and the direction means, for computing a first correlation between the vertical acceleration and forward-shifted horizontal acceleration information obtained from the shift means, and second correlation means, communicatively coupled to the shift means and the direction means, for computing a second correlation between the vertical acceleration and backward-shifted horizontal acceleration information obtained from the shift means.

Implementations of such a mobile device may additionally or alternatively include one or more of the following features. The direction means includes a combiner means, communicatively coupled to the first correlation means and the second correlation means, for subtracting the second correlation from the first correlation. The misalignment means is configured to compute the misalignment angle between the forward motion direction of the user of the device and the orientation of the device by performing eigen analysis of a result of the combiner means. The misalignment means is configured to resolve forward/backward ambiguity associated with the misalignment angle according to positivity or negativity of the result of the combiner means. The step detector is communicatively coupled to the accelerometer and configured to identify the pedestrian steps of the user of the device based on the acceleration information generated by the accelerometer. The accelerometer is configured to identify a direction of gravity relative to the device and the misalignment means is further configured to determine the orientation of the device based on the direction of gravity relative to the device.

An example of a computer program product according to the disclosure resides on a non-transitory processor-readable medium and includes processor-readable instructions configured to cause a processor to obtain acceleration information associated with a mobile device, divide the acceleration information according to respective detected pedestrian steps of a user of the mobile device, identify a forward motion direction of the user of the mobile device based on the acceleration information and the detected pedestrian steps, and compute a misalignment angle between the forward motion direction of the mobile device and an orientation of the mobile device with respect to the user of the mobile device.

Implementations of such a computer program product may include one or more of the following features. The instructions configured to cause a processor to identify the forward motion direction are further configured to cause the processor to obtain first acceleration information corresponding to a first pedestrian step of the user, obtain second acceleration information corresponding to a second pedestrian step of the user that follows the first pedestrian step, and sum the first acceleration information and the second acceleration information. The acceleration information includes vertical acceleration information and horizontal acceleration information and the instructions configured to cause a processor to identify the forward motion direction are further configured to cause the processor to compute a first correlation result between vertical acceleration information of a selected pedestrian step and horizontal acceleration information of the selected pedestrian step shifted forward in time by about one quarter of a pedestrian step, compute a second correlation result between the vertical acceleration information of the selected pedestrian step and horizontal acceleration information of the selected pedestrian step shifted backward in time by about one quarter of a pedestrian step, and subtract the second correlation result from the first correlation result to obtain a combined correlation result. The instructions configured to cause a processor to compute the misalignment angle are further configured to cause the processor to compute the misalignment angle using eigen analysis of the combined correlation result. The instructions configured to cause a processor to compute the misalignment angle are further configured to cause the processor to resolve forward/backward ambiguity of the misalignment angle based on positivity or negativity of the combined correlation result.

Items and/or techniques described herein may provide one or more of the following capabilities, as well as other capabilities not mentioned. Cost and power requirements associated with sensors for tracking motion of a mobile device can be reduced. The accuracy of pedestrian motion direction computation can be increased by leveraging the biomechanics of pedestrian motion. Monitoring of device motion direction can be performed with increased robustness to changes in sensor orientation and/or loss of calibration data. While at least one item/technique-effect pair has been described, it may be possible for a noted effect to be achieved by means other than that noted, and a noted item/technique may not necessarily yield the noted effect.

### BRIEF DESCRIPTION OF THE DRAWINGS

FIGS. 1-3 are graphical illustrations of a technique for computing and applying a misalignment angle in a position location system for a moving pedestrian user.

FIG. 4 is a schematic diagram of a wireless telecommunication system.

FIG. 5 is a block diagram of components of a mobile station shown in FIG. 1.

FIG. 6 is a partial functional block diagram of the mobile station shown in FIG. 2.

FIG. 7 is a graphical illustration of a technique for computing and applying a misalignment angle in a position location system.

FIG. 8 is a partial functional block diagram of a system for computing a forward motion direction of a mobile station.

FIG. 9 is a block flow diagram of a process of computing the direction of motion of a mobile device.

FIG. 10 is a block flow diagram of an alternative process of computing the direction of motion of a mobile device.

### DETAILED DESCRIPTION

Techniques are described herein for measuring the sensor orientation of a mobile device in relation to the motion direction of a pedestrian user of the mobile device. For example, a mobile device, such as a mobile telephone handset, a laptop or tablet computer, a PDA, etc., can collect data from a sensor ensemble composed of one or more orientation sensors. A step tracker, such as a pedometer or step counter, collects further data relating to pedestrian steps (e.g., walking, jogging, or running steps, etc.) of a user of the mobile device, based on which the data collected by the orientation sensors are partitioned according to their corresponding pedestrian steps. The sensor data corresponding to respective steps are processed to identify a direction of forward motion (e.g., in relation to earth, as determined by obtaining the direction of gravity from data collected by the orientation sensors). Cancellation of the transverse motion component of the motion data is performed to improve identification of the direction of forward motion. Based on the computed direction of forward motion, a MA between the direction of forward motion and the orientation of the mobile device is determined These techniques are examples only and are not limiting of the disclosure or the claims.

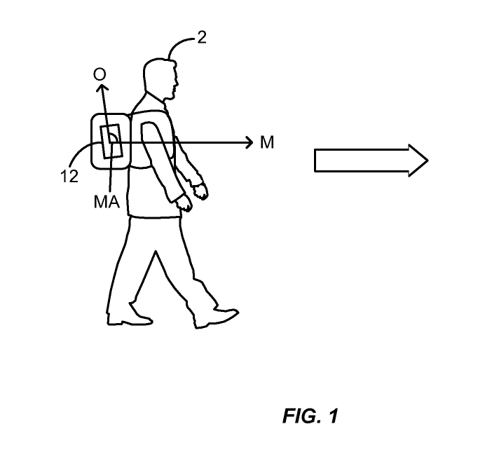

When data from a satellite navigation system, such as GPS data, are available, the MA can be calibrated as a filtered delta between a course over ground reading given by the satellite navigation system and the compass heading. However, in the event that connection to the satellite navigation system is lost, the MA may require autonomous measurement. The MA can be measured independently of satellite navigation data based on sensor data relating to the orientation of a mobile device 12, as shown by FIGS. 1-3. However, the complexity of these computations is significantly increased in the case of a mobile pedestrian user 2 of the mobile device 12. For instance, a user 2 of a mobile device 12 may position the mobile device 12 in a variety of orientations, corresponding to positioning of the mobile device 12 in a handbag or backpack, as illustrated by FIG. 1; on a belt or other similar item of clothing, as illustrated by FIG. 2; in the user's hand, as illustrated by FIG. 3; in a coat or pants pocket; or the like. Each of these orientations can affect the MA associated with the mobile device 12. Further, the orientation of the mobile device 12 may change during movement due to various factors. For example, the user 2 can move the mobile device 12 between different positions (e.g., from the user's pocket to the user's hand, etc.), the mobile device 12 can shift between varying orientations (e.g., such as in a case where the mobile device 12 is placed in the backpack of a user 2, as shown by FIG. 1), or normal body movements associated with walking or running can cause changes to the orientation of the mobile device 12. Therefore, techniques are described herein by which the MA is made adaptable to the current orientation of the mobile device 12.

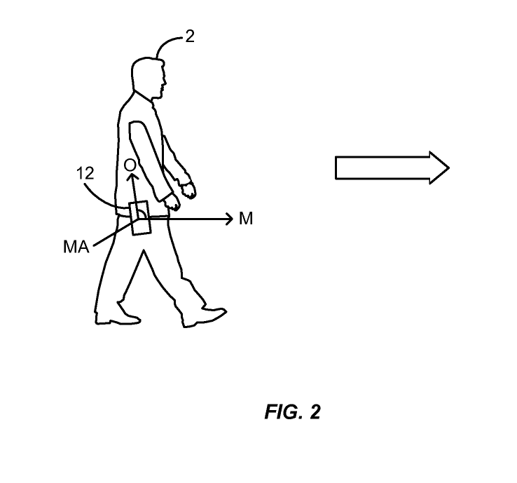

Referring to FIG. 4, a wireless communication system 10 includes mobile access terminals 12 (ATs), base transceiver stations (BTSs) 14 disposed in cells 16, and a base station controller (BSC) 18. The system 10 may support operation on multiple carriers (waveform signals of different frequencies). Multi-carrier transmitters can transmit modulated signals simultaneously on the multiple carriers. Each modulated signal may be a

Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc.

The BTSs 14 can wirelessly communicate with the ATs 12 via antennas. Each of the BTSs 14 may also be referred to as a base station, an access point, an access node (AN), a Node B, an evolved Node B (eNB), etc. The BTSs 14 are configured to communicate with the ATs 12 under the control of the BSC 18 via multiple carriers. Each of the BTSs 14 can provide communication coverage for a respective geographic area, here the respective cells 16. Each of the cells 16 of the BTSs 14 is partitioned into multiple sectors as a function of the base station antennas.

The system 10 may include only macro base stations 14 or it can have base stations 14 of different types, e.g., macro, pico, and/or femto base stations, etc. A macro base station may cover a relatively large geographic area (e.g., several kilometers in radius) and may allow unrestricted access by terminals with service subscription. A pico base station may cover a relatively small geographic area (e.g., a pico cell) and may allow unrestricted access by terminals with service subscription. A femto or home base station may cover a relatively small geographic area (e.g., a femto cell) and may allow restricted access by terminals having association with the femto cell (e.g., terminals for users in a home).

The ATs 12 can be dispersed throughout the cells 16. The ATs 12 may be referred to as terminals, mobile stations, mobile devices, user equipment (UE), subscriber units, etc. The ATs 12 shown in FIG. 4 include cellular phones and a wireless router, but can also include personal digital assistants (PDAs), other handheld devices, netbooks, notebook computers, etc.

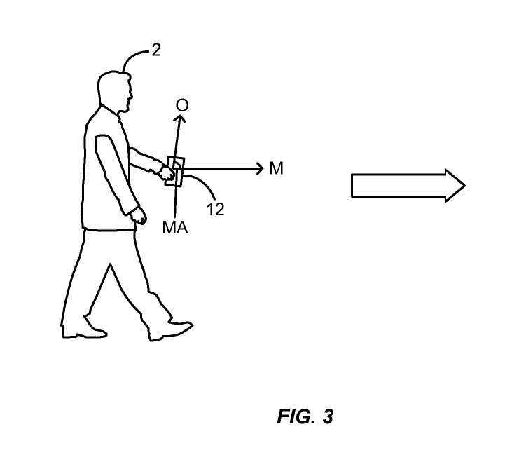

Referring also to FIG. 5, an example one of the ATs 12 comprises a computer system including a processor 20, memory 22 including software 24, input/output (I/O) device(s) 26 (e.g., a display, speaker, keypad, touch screen or touchpad, etc.), accelerometer(s) 28, antenna(s) 30, and a satellite positioning system (SPS) receiver 32. The antennas 30 include a transceiver configured to communicate bi-directionally with the BTSs 14 via the antennas 30. Here, the processor 20 is an intelligent hardware device, e.g., a central processing unit (CPU) such as those made by Intel® Corporation or AMD®, a microcontroller, an application specific integrated circuit (ASIC), etc. The memory 22 includes non-transitory storage media such as random access memory (RAM) and read-only memory (ROM). The memory 22 stores the software 24 which is computer-readable, computer-executable software code containing instructions that are configured to, when executed, cause the processor 20 to perform various functions described herein. Alternatively, the software 24 may not be directly executable by the processor 20 but is configured to cause the computer, e.g., when compiled and executed, to perform the functions.

The accelerometer(s) 28 are configured to collect data relating to motion and/or orientation of the mobile device 12 as well as changes in the motion and/or orientation of the mobile device 12 over time. The accelerometer(s) 28 can provide information over time, e.g., periodically, such that present and past orientations and/or motion directions can be compared to determine changes in the motion direction and/or orientation of the mobile device 12. Further, the accelerometer(s) 28 are configured to provide information as to gravitational acceleration such that the direction of gravity relative to the mobile device 12 can be determined.

Within the mobile device 12, the accelerometer(s) 28 comprise a sensor ensemble that collects information relating to the orientation of the mobile device 12. In addition to an accelerometer 28, the sensor ensemble may also include a gyroscope that measures rotational acceleration of the mobile device 12 with respect to one or more of roll, pitch or yaw; a magnetometer or compass configured to provide an indication of the direction of magnetic north relative to the mobile device 12; and/or other sensor mechanisms. The sensor ensemble is associated with a set of three axes, which respectively correspond to the three spatial dimensions of the mobile device 12. These axes, in turn, define a coordinate plane for the sensor ensemble and its associated mobile device 12. By way of example, a coordinate plane for the mobile device 12 may be defined by three orthogonal axes that respectively run along the length, width and depth of the mobile device 12.

The SPS receiver 32 includes appropriate equipment for monitoring navigation signals from satellites and determining position of the mobile device 12. The SPS receiver 32 can monitor navigation signals from satellites corresponding to any suitable satellite navigation system, such as GPS, GLONASS, the Beidou navigation system, the Galileo positioning system, etc. Here, the SPS receiver 32 includes one or more SPS antennas, and can either communicate with the processor 20 to determine location information or can use its own processor for processing the received satellite navigation signals to determine the location of the mobile device 12. Further, the SPS receiver 32 can communicate with other entities such as a position determination entity and/or the BTS 14 in order to send and/or receive assistance information for use in determining the location of the mobile device 12.

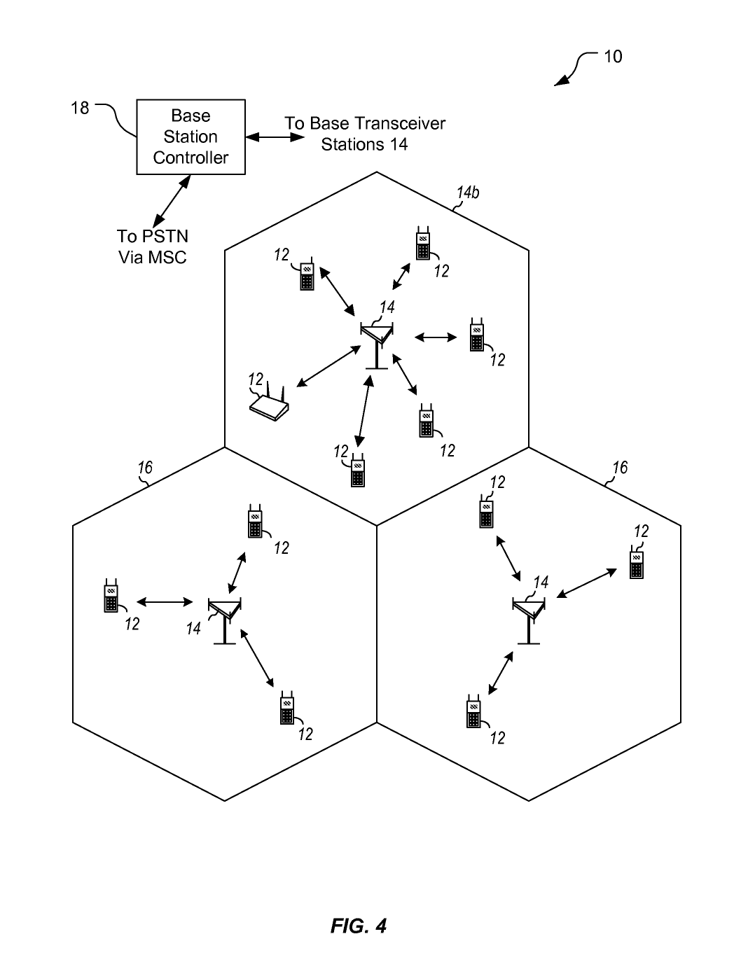

Information obtained by an accelerometer 28 associated with the mobile device 12 is provided to a step detector 40, a motion direction tracking module 42, and/or a MA computation module 44 for further processing, as further shown by FIG. 6. The step detector 40 analyzes the motion of the mobile device 12 to identify movement patterns or signatures corresponding to pedestrian steps (e.g., running, walking, jogging, etc.). Upon identifying device movement that matches that of a pedestrian step, the step detector 40 can further collect or otherwise determine information corresponding to the step, such as the step length, the duration of the step in time, a count of consecutive identified steps, or the like.

Here, the step detector 40 analyzes information from the accelerometer(s) 28 corresponding to movement of the mobile device 12 in order to detect respective pedestrian steps. Alternatively, the step detector 40 can obtain motion information corresponding to the mobile device 12 using other motion or orientation sensors not shown in FIG. 6. As another alternative, the step detector 40 can track movement of the mobile device 12 independently of other sensors associated with the mobile device 12. Further, the step detector 40 can be implemented as one or more software modules (e.g., by the processor 20 in conjunction with the software 24 stored in the memory 22), one or more hardware components (e.g., a pedometer, step counter, etc.), or a combination of hardware and software. The step detector 40 can be physically coupled to the mobile device 12, worn by a user 2 of the mobile device 12, and/or placed in any other location suitable for monitoring the motion of the mobile device 12. In the event that the step detector 40 is not physically coupled to the mobile device 12, the step detector 40 can be communicatively connected to the mobile device 12 via any known wired and/or wireless communication technology.

The motion direction tracking module 42 and the MA computation module 44 are implemented by the processor 20 in conjunction with the software 24 stored in the memory 22. These modules, as implemented by the processor 20 (e.g., by executing software algorithms), are configured to process the information from the accelerometer(s) 28 in order to aid one or more applications associated with the mobile device 12 in determining the direction of motion of the mobile device 12 (e.g., expressed in relation to north).

The motion direction tracking module 42 can express the direction of motion of the mobile device 12 as an angle relative to north, e.g., with respect to a horizontal plane in an earth-based coordinate system such as the north-east-down (n-e-d) coordinate system. As used herein, the term “north” refers to any known definition, including true north, magnetic north, etc. In some cases, the motion direction tracking module 42 can be configured to translate a motion direction determined in relation to true north into a motion direction given in relation to magnetic north, or vice versa, using one or more compensation algorithms (e.g., based on magnetic declination or other parameters).

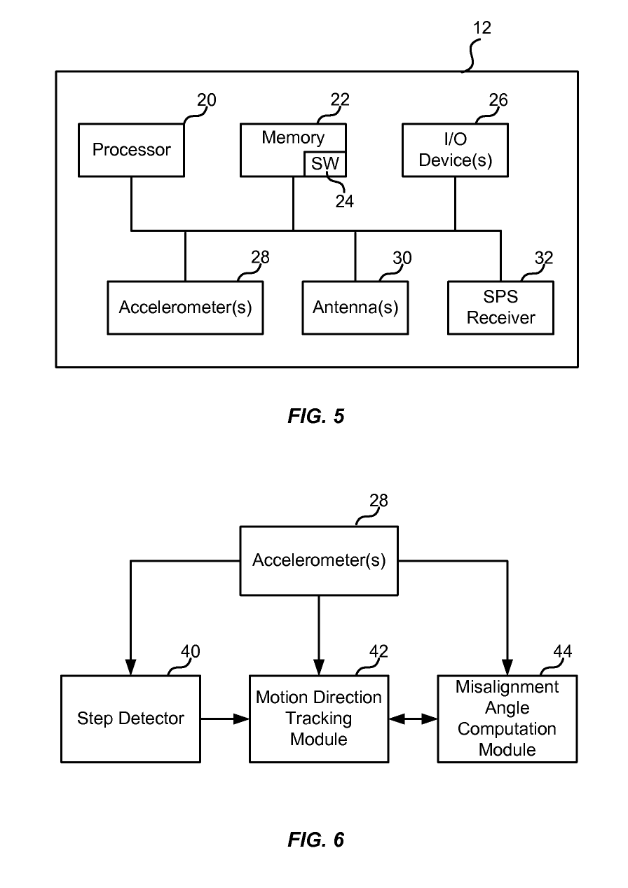

For a sensor-aided pedestrian navigation application running on the mobile device 12, the MA computation module 44 is utilized to determine the angular offset (the MA) between the orientation of the mobile device 12 and the direction of forward motion of the mobile device 12, as given by the motion direction tracking module 42. For example, as shown by FIG. 7, the MA is defined by the angular difference between the direction of motion M of a mobile device 12 and the direction of orientation O of the mobile device. By calculating and utilizing the MA, the direction of motion M of the mobile device 12 can be obtained in cases in which conventional motion direction techniques fail. More particularly, as the MA can have any value (e.g., from 0 to 360 degrees) depending on the direction of orientation O of the mobile device 12, without the MA even approximate conversion of device heading to motion direction is not possible.

The MA is utilized to facilitate positioning of the mobile device 12. For example, a mobile device 12 can be equipped with a compass or other mechanisms to provide information indicating the heading of the mobile device 12, which is defined as the direction at which the mobile device is oriented (e.g., in relation to magnetic north) within a given precision or tolerance amount. However, unless the mobile device 12 is immovably positioned such that it is always oriented in the direction of motion, the compass heading of the mobile device 12 alone does not represent the direction in which the mobile device 12 is moved. Thus, the MA can be utilized to convert the direction of orientation of the mobile device 12 to the direction of motion in the event that the mobile device 12 is not oriented in the direction of motion. As an example, the direction of motion in a compass-aided dead reckoning application can be computed as the compass heading plus the MA.

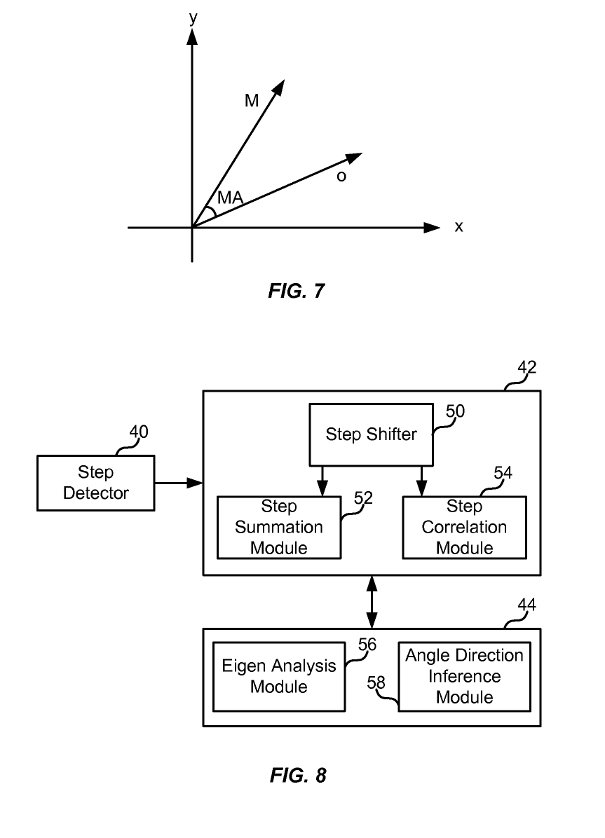

The motion direction tracking module 42 and the MA computation module 44 can operate based on sensor data, information obtained from a step detector 40, etc., to determine the MA associated with movement of a mobile device 12 being carried by a pedestrian user 2, as shown by FIG. 8. Initially, based on data collected from accelerometer(s) 28 and/or the step detector 40, pedestrian steps are identified and the direction of gravity relative to the sensor axes of the mobile device 12 is determined. These initial computations form a basis for the operation of the motion direction tracking module 42 and the MA computation module 44, as described below.

With regard to pedestrian motion, such as walking, running, etc., the direction of motion changes within a given pedestrian step and between consecutive steps based on the biomechanics of pedestrian motion. For example, rather than proceeding in a constant forward direction, a moving pedestrian shifts left to right (e.g., left during a step with the left foot and right during a step with the right foot) with successive steps and vertically (e.g., up and down) within each step. Accordingly, transverse (lateral) acceleration associated with a series of pedestrian steps cycles between left and right with a two-step period while forward and vertical acceleration cycle with a one-step period.

The motion direction tracking module 42 can leverage the above properties of pedestrian motion to isolate the forward component of motion from the vertical and transverse components. For example, the motion direction tracking module 42 records acceleration information obtained from accelerometer(s) 28 (e.g., in a buffer) over consecutive steps. To rectify forward acceleration and suppress or cancel the transverse component of the acceleration, the motion direction tracking module 42 utilizes a step shifter 50 and a step summation module 52 to sum odd and even steps. In other words, the step shifter 50 shifts acceleration data corresponding to a series of pedestrian steps in time by one step. Subsequently, the step summation module 52 sums the original acceleration information with the shifted acceleration information. As noted above, transverse changes sign with consecutive steps with a two-step period due to body rotation and rolling while forward and vertical acceleration exhibit a one-step period. As a result, summing pedestrian steps after a one-step shift reduces transverse acceleration while having minimal impact on vertical or forward acceleration.

If the mobile device 12 is not centrally positioned on a pedestrian user's body or shifts orientation during the pedestrian motion, transverse acceleration will not be symmetrical from step to step. Accordingly, while the step shifter 50 and step summation module 52 operate to reduce the transverse component of acceleration, these modules may not substantially eliminate the transverse acceleration. To enhance the removal of transverse acceleration, a step correlation module 54 can further operate on the acceleration data obtained from the accelerometer(s) 28.

As a pedestrian steps forward (e.g., when walking), the center of gravity of the pedestrian moves up at the beginning of the step and down at the end of the step. Similarly, the forward speed of the pedestrian decreases when the foot of the pedestrian reaches the ground at the end of a step and increases during the step. This relationship between forward and vertical motion during the progression of a pedestrian step is leveraged by the step correlation module 54 in further canceling transverse acceleration. In particular, if the acceleration associated with a pedestrian step is viewed as a periodic function, it can be observed that the vertical acceleration and forward acceleration associated with the step are offset by approximately a quarter of a step (e.g., 90 degrees). Accordingly, the step correlation module 54 correlates vertical acceleration with horizontal acceleration shifted (by the step shifter 50) by one quarter step both forwards and backwards (e.g., +/− 90 degrees).

After shifting and correlation as described above, the vertical/forward correlation is comparatively strong due to the biomechanics of pedestrian motion, while the vertical/transverse correlation is approximately zero. Thus, the correlations between vertical and horizontal acceleration shifted forward and backward by one quarter step are computed, and the forward shifted result is subtracted from the backward shifted result (since the results of the two correlations are opposite in sign) to further reduce the transverse component of acceleration.

Once the motion direction tracking module 42 substantially cancels transverse acceleration as discussed above, the MA computation module 44 determines the angle between the forward component of acceleration and the orientation of the mobile device 12. Here, the MA computation module 44 identifies the MA via eigen analysis, as performed by an eigen analysis module 56, and further processing performed by an angle direction inference module 58. Based on information provided by the motion direction tracking module 42, the eigen analysis module 56 determines the orientation of the sensor axes of the mobile device with respect to the earth, from which a line corresponding to the direction of motion of the mobile device 12 is obtained. The angle direction inference module 58 analyzes the obtained line, as well as forward and vertical acceleration data corresponding to the corresponding pedestrian step(s), to determine the direction of the MA based on the direction of motion of the mobile device 12 (e.g., forward or backward along the obtained line). By doing so, the angle direction inference module 58 operates to resolve forward/backward ambiguity associated with; the MA.

The angle direction inference module 58 leverages the motion signature of a pedestrian step to determine the direction of the MA. As discussed above, forward and vertical acceleration corresponding to a pedestrian step are related due to the mechanics of leg rotation, body movement, and other factors associated with pedestrian motion. Thus, the angle direction inference module utilizes knowledge of these relationships to identify whether a motion direction is forward or backward along a given line.

While the above discussion relates to obtaining a two-dimensional motion direction, e.g., with respect to a horizontal plane, similar techniques could be utilized to obtain a direction of motion in three dimensions. Thus, the techniques described herein can be extended to account for changes in altitude, pedestrian motion along an uneven surface, and/or other factors impacting the direction of motion in three dimensions.

Additionally, the techniques described above can be extended to leverage a gyroscope in addition to accelerometer(s) 28. With further reference to the biomechanics of pedestrian motion, leg rotation and other associated movements during a pedestrian step can be classified as angular movements, e.g., measured in terms of pitch or roll. Accordingly, a gyroscope can be used to separate gravity from acceleration due to movement such that the reference frame for computation can be rotated to account for the orientation of the mobile device 12 prior to the calculations described above.

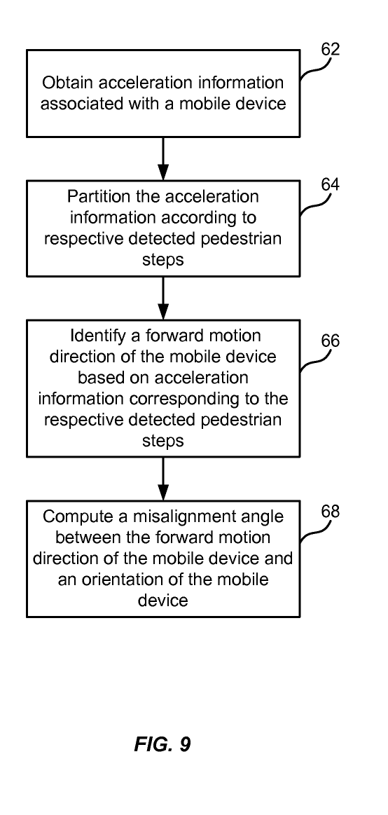

Referring to FIG. 9, with further reference to FIGS. 1-8, a process 60 of computing the direction of motion of a mobile device 12 includes the stages shown. The process 60 is, however, an example only and not limiting. The process 60 can be altered, e.g., by having stages added, removed, rearranged, combined, and/or performed concurrently. Still other alterations to the process 60 as shown and described are possible.

At stage 62, acceleration information associated with a mobile device 12 is obtained. This information can be obtained by one or more accelerometers 28 and/or other sensor devices associated with the mobile device 12. At stage 64, the acceleration information obtained at stage 62 is partitioned according to respective detected pedestrian steps (e.g., running steps, walking steps, etc.). The pedestrian steps are detected by a step detector 40, with assistance from or independently of an accelerometer 28.

At stage 66, a forward motion direction of the mobile device 12 is identified based on the acceleration information corresponding to the respective detected pedestrian steps, as partitioned at stage 64. The forward motion direction is identified at stage 66 by a motion direction tracking module 42, e.g., with the aid of a step summation module 52 and/or a step correlation module 54 implemented by a processor 20 executing software 24 stored on a memory 22 as described above.

At stage 68, a MA between the forward motion direction of the mobile device 12 and an orientation of the mobile device 12 is computed. The MA is computed by, e.g., a MA computation module 44 implemented by a processor 20 executing software 24 stored on a memory 22, based on eigen analysis and direction inference procedures as described above.

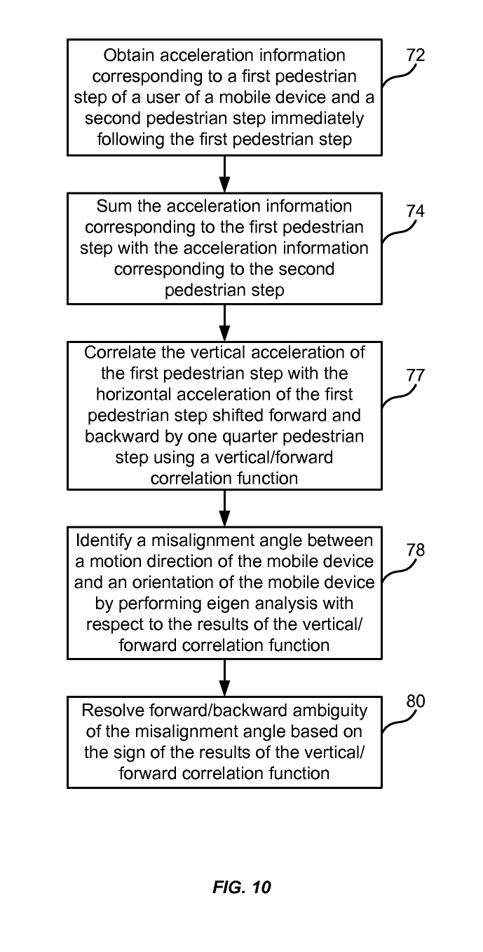

Referring next to FIG. 10, with further reference to FIGS. 1-8, an alternative process 70 of computing the direction of motion of a mobile device 12 includes the stages shown. The process 70 is, however, an example only and not limiting. The process 70 can be altered, e.g., by having stages added, removed, rearranged, combined, and/or performed concurrently. Still other alterations to the process 70 as shown and described are possible.

At stage 72, acceleration information is obtained that corresponds to a first pedestrian step (e.g., running step, walking step, etc.) of a user 2 of a mobile device 12 and a second pedestrian step immediately following the first pedestrian step. The acceleration information can be obtained by an accelerometer 28 associated with the mobile device 12 and/or by any other suitable means. Further, the first pedestrian step and the second pedestrian step can be delineated by a step detector 40, which can operate based on data obtained from the accelerometer 28 or independent movement data.

At stage 74, the acceleration information corresponding to the first pedestrian step is summed (e.g., by a step summation module 52 with shifting by a step shifter 50, as implemented by a processor 20 executing software 24 stored on a memory 22) with the acceleration information corresponding to the second pedestrian step. At stage 76, the acceleration information is further processed by correlating the vertical acceleration of the first pedestrian step with the horizontal acceleration of the first pedestrian step shifted forward and backward by one quarter pedestrian step using a vertical/forward correlation function. Here, the correlation function is implemented by a step correlation module 54 or other suitable mechanisms. Further, a step shifter 50 is used to provide the forward and backward shifting utilized in the correlations. Vertical acceleration and horizontal acceleration corresponding to the first pedestrian step are separated based on acceleration data provided by an accelerometer 28 (e.g., based on measurements corresponding to different sensor axes with respect to gravity, etc.), a step detector 40, or the like.

At stage 78, a misalignment angle between a motion direction of the mobile device 12 and an orientation of the mobile device 12 is identified by performing eigen analysis (e.g., via an eigen analysis module 56 associated with a MA computation module 44, each of which are implemented by a processor 20 executing software 24 stored on a memory 22) with respect to the results of the vertical/forward correlation function at stage 76. At stage 80, forward/backward ambiguity of the misalignment angle is resolved by an angle direction inference module 58 or other suitable mechanisms based on the sign (i.e., positivity or negativity) of the results of the vertical/forward correlation function utilized at stage 78.

Upon computation of the MA as shown at stage 80, various further functions can be performed. For example, the eigen analysis performed at stage 78 can be utilized to obtain an error estimate for the computed MA. As another example, the computed MA can be applied to a motion direction estimate to enhance the accuracy of pedestrian navigation applications or other appropriate applications. Other uses of the computed MA are also possible.

Still other techniques are possible.

What is claimed is:

1. A mobile device comprising:
an accelerometer configured to generate acceleration information relating to motion of the device and to identify information relating to an orientation of the device;
a step detector configured to identify pedestrian steps of a user of the device and corresponding pedestrian step duration information;
a motion direction tracking module communicatively coupled to the accelerometer and the step detector and configured to separate a forward motion direction of the device with respect to the user of the device indicated by the acceleration information from vertical and transverse motion directions of the device based on the pedestrian steps identified by the step detector; and
a misalignment angle computation module communicatively coupled to the accelerometer and the motion direction tracking module and configured to determine a misalignment angle between the forward motion direction of the device and the orientation of the device with respect to the user of the device.

2. The device of claim 1 further comprising:
a step shifter module communicatively coupled to the motion direction tracking module and configured to shift the acceleration information in time by about one pedestrian step in accordance with the pedestrian step duration information, thereby obtaining shifted acceleration information; and
a step summation module communicatively coupled to the step shifter module and the motion direction tracking module and configured to combine the acceleration information with the shifted acceleration information.

3. The device of claim 1 wherein the acceleration information comprises horizontal acceleration information and vertical acceleration information and the device further comprises:
a step shifter module communicatively coupled to the motion direction tracking module and configured to shift the acceleration information forward and backward in time by about a quarter pedestrian step in accordance with the pedestrian step duration, thereby obtaining forward-shifted acceleration information and backward-shifted acceleration information, respectively; and
a step correlation module communicatively coupled to the step shifter module and the motion direction tracking module and configured to compute a first correlation of vertical acceleration information with forward-shifted horizontal acceleration and to compute a second correlation of vertical acceleration information with backward-shifted horizontal acceleration information.

4. The device of claim 3 wherein the motion direction tracking module is further configured to subtract the first correlation from the second correlation, thereby obtaining a resulting correlation.

5. The device of claim 1 wherein the misalignment angle computation module comprises an eigen analysis module configured to determine the misalignment angle by performing eigen analysis of the resulting correlation with respect to the forward motion direction of the device.

6. The device of claim 5 wherein the acceleration information comprises horizontal acceleration information and vertical acceleration information and the device further comprises an angle direction inference module communicatively coupled to the misalignment angle computation module and configured to resolve forward/backward ambiguity associated with the misalignment angle by analyzing horizontal acceleration information corresponding to the forward motion direction of the device in relation to the vertical acceleration information based on positivity or negativity of the resulting correlation.

7. The device of claim 1 wherein the step detector comprises a pedometer.

8. The device of claim 1 wherein the step detector is communicatively coupled to the accelerometer and configured to identify the pedestrian steps of the user of the device based on the acceleration information generated by the accelerometer.

9. The device of claim 1 wherein the accelerometer is configured to identify a direction of gravity relative to the device and the misalignment angle computation module is further configured to determine the orientation of the device based on the direction of gravity relative to the device.

10. A method of identifying a misalignment angle associated with motion of a mobile device, the method comprising:
obtaining acceleration information associated with the mobile device;
partitioning the acceleration information according to respective detected pedestrian steps of a user;
identifying a forward motion direction of the user of the mobile device based on the acceleration information and the detected pedestrian steps; and
computing a misalignment angle between the forward motion direction of the user of the mobile device and an orientation of the mobile device.

11. The method of claim 10 wherein the obtaining comprises:
obtaining first acceleration information corresponding to a first pedestrian step of the user; and
obtaining second acceleration information corresponding to a second pedestrian step of the user that follows the first pedestrian step; and
the identifying comprises summing the first acceleration information with the second acceleration information.

12. The method of claim 10 wherein the obtaining comprises obtaining vertical acceleration information and horizontal acceleration information associated with the user of the mobile device and the identifying comprises correlating the vertical acceleration information of a selected pedestrian step with the horizontal acceleration information of the selected pedestrian step shifted forward and backward in time by about one quarter of a pedestrian step based on a vertical/forward correlation function.

13. The method of claim 12 wherein the computing comprises computing the misalignment angle between the forward motion direction of the mobile device and the orientation of the mobile device by performing eigen analysis of results of the vertical/forward correlation function.

14. The method of claim 13 wherein the computing further comprises resolving forward/backward ambiguity of the misalignment angle based on positivity or negativity of the results of the vertical/forward correlation function.

15. The method of claim 10 further comprising identifying the respective detected steps of the user based on the acceleration information.

16. A mobile device comprising:
an accelerometer configured to generate acceleration information relating to motion of the device and to identify information relating to an orientation of the device;
a step detector configured to identify pedestrian steps of a user of the device and corresponding pedestrian step duration information;
direction means, communicatively coupled to the accelerometer and the step detector, for inferring a forward motion direction of the device from the acceleration information based on the pedestrian steps identified by the step detector; and
misalignment means, communicatively coupled to the accelerometer and the direction means, for determining a misalignment angle between the forward motion direction of the user of the device and the orientation of the device with respect to the user of the device.

17. The device of claim 16 further comprising:
shift means, communicatively coupled to the direction means, for shifting the acceleration information in time by an interval having a length of approximately one pedestrian step in accordance with the pedestrian step duration information; and
summation means, communicatively coupled to the shift means and the direction means, for combining the acceleration information with a result of the shift means.

18. The device of claim 16 wherein the acceleration information comprises horizontal acceleration information and vertical acceleration information and the device further comprises:
shift means, communicatively coupled to the direction means, for shifting the horizontal acceleration information forward and backward in time by an interval having a length of approximately one quarter pedestrian step in accordance with the pedestrian step duration information;
first correlation means, communicatively coupled to the shift means and the direction means, for computing a first correlation between the vertical acceleration and forward-shifted horizontal acceleration information obtained from the shift means; and
second correlation means, communicatively coupled to the shift means and the direction means, for computing a second correlation between the vertical acceleration and backward-shifted horizontal acceleration information obtained from the shift means.

19. The device of claim 18 wherein the direction means comprises a combiner means, communicatively coupled to the first correlation means and the second correlation means, for subtracting the second correlation from the first correlation.

20. The device of claim 19 wherein the misalignment means is configured to compute the misalignment angle between the forward motion direction of the user of the device and the orientation of the device by performing eigen analysis of a result of the combiner means.

21. The device of claim 20 wherein the misalignment means is configured to resolve forward/backward ambiguity associated with the misalignment angle according to positivity or negativity of the result of the combiner means.

22. The device of claim 16 wherein the step detector is communicatively coupled to the accelerometer and configured to identify the pedestrian steps of the user of the device based on the acceleration information generated by the accelerometer.

23. The device of claim 16 wherein the accelerometer is configured to identify a direction of gravity relative to the device and the misalignment means is further configured to determine the orientation of the device based on the direction of gravity relative to the device.

24. A computer program product residing on a non-transitory processor-readable medium and comprising processor-readable instructions configured to cause a processor to:
obtain acceleration information associated with a mobile device;
divide the acceleration information according to respective detected pedestrian steps of a user of the mobile device;
identify a forward motion direction of the user of the mobile device based on the acceleration information and the detected pedestrian steps; and
compute a misalignment angle between the forward motion direction of the mobile device and an orientation of the mobile device with respect to the user of the mobile device.

25. The computer program product of claim 24 wherein the instructions configured to cause a processor to identify the forward motion direction are further configured to cause the processor to:
obtain first acceleration information corresponding to a first pedestrian step of the user;
obtain second acceleration information corresponding to a second pedestrian step of the user that follows the first pedestrian step; and
sum the first acceleration information and the second acceleration information.

26. The computer program product of claim 24 wherein the acceleration information comprises vertical acceleration information and horizontal acceleration information and the instructions configured to cause a processor to identify the forward motion direction are further configured to cause the processor to:
compute a first correlation result between vertical acceleration information of a selected pedestrian step and horizontal acceleration information of the selected pedestrian step shifted forward in time by about one quarter of a pedestrian step;
compute a second correlation result between the vertical acceleration information of the selected pedestrian step and horizontal acceleration information of the selected pedestrian step shifted backward in time by about one quarter of a pedestrian step; and
subtract the second correlation result from the first correlation result to obtain a combined correlation result.

27. The computer program product of claim 26 wherein the instructions configured to cause a processor to compute the misalignment angle are further configured to cause the processor to compute the misalignment angle using eigen analysis of the combined correlation result.

28. The computer program product of claim 27 wherein the instructions configured to cause a processor to compute the misalignment angle are further configured to cause the processor to resolve forward/backward ambiguity of the misalignment angle based on positivity or negativity of the combined correlation result.
